(19) United States
(12) Patent Application Publication
(10) Pub. No.: US 2025/0028941 A1
(43) Pub. Date: Jan. 23, 2025

(54) GENERATIVE ARTIFICIAL INTELLIGENCE FOR GENERATING CONTEXTUAL RESPONSES

(71) Applicant: Google LLC, Mountain View, CA (US)

(72) Inventors: Jason Sean Krueger, Seattle, WA (US); Walter Alejandro Vulej, Mountain View, CA (US); Joshua Brian Braverman, Oakland, CA (US); Nicholas James Reid, Seattle, WA (US)

(21) Appl. No.: 18/776,145

(22) Filed: Jul. 17, 2024

Related U.S. Application Data
(60) Provisional application No. 63/527,547, filed on Jul. 18, 2023.

(51) Int. Cl. G06N 3/0475

(52) U.S. Cl. CPC G06N 3/0475

(57) ABSTRACT

Methods, systems, and apparatus, including computer programs encoded on a computer storage medium, for using artificial intelligence to display responses and digital components in a conversational user interface. A method includes initiating a user session with a conversational user interface of an artificial intelligence system. During the user session, the method includes receiving, by the artificial intelligence system, one or more prompts; displaying, in the conversational user interface, one or more digital components that each include content related to a corresponding item based at least in part on the one or more prompts, detecting, for each displayed digital component, one or more user interaction events; updating a user interest record, and displaying one or more additional digital components in the conversational user interface based at least in part on the user interest record.

### CROSS-REFERENCE TO RELATED APPLICATION

This application claims priority to U.S. Provisional Application No. 63/527,547, filed on Jul. 18, 2023. The prior application is considered part of and is incorporated by reference in the disclosure of this application.

### BACKGROUND

This specification relates to data processing, artificial intelligence, and using contextual information to generate responses in artificial intelligence-based conversational user interfaces.

### SUMMARY

In general, one innovative aspect of the subject matter described in this specification can be embodied in methods that include the actions of initiating a user session with a conversational user interface of an artificial intelligence system that displays, within the conversational user interface, responses to user prompts received during the user session, the responses being generated using one or more machine learning models of the artificial intelligence system; during the user session: receiving, by the artificial intelligence system, one or more prompts provided in the conversational user interface by a user; displaying, in the conversational user interface, one or more digital components that each include content related to a corresponding item based at least in part on the one or more prompts; detecting, for each displayed digital component, one or more user interaction events indicative of whether the user interacted with the displayed digital component while the digital component was displayed in the conversational user interface; updating a user interest record that includes data indicating a level of interest of the user in a set of items, wherein the level of interest for each item is determined by the one or more machine learning models based on the one or more user interaction events for each digital component; and displaying one or more additional digital components in the conversational user interface based at least in part on the user interest record. Other implementations of this aspect include corresponding apparatus, systems, and computer programs, configured to perform the aspects of the methods, encoded on computer storage devices.

These and other embodiments can each optionally include one or more of the following features. The level of interest for each item determined by the one or more machine learning models can be further based on information related to one or more previous user sessions of the user with the artificial intelligence system.

Updating the user interest record can include including the data of the user interest record in one or more prompts to the one or more machine learning models; and receiving a recommended update to the user interest record from the one or more machine learning models.

Displaying one or more additional digital components in the conversational user interface can include providing the data of the user interest record with a request for a digital component to the artificial intelligence system.

The user interest record can be maintained across a plurality of user sessions, and the user interest record can be updated during each user session of the plurality of user sessions.

Aspects can include constraining a data size of the user interest record.

Aspects can include, after displaying the one or more additional digital components in the conversational user interface: detecting, for each additional displayed digital component, one or more user interaction events indicative of whether the user interacted with the displayed additional digital component while the additional digital component was displayed in the conversational user interface; and updating the user interest record based on the one or more user interaction events for each additional digital component.

Data indicating a level of interest of the user in a set of items can include a weight for each item in the set of items, wherein the weight for each item is indicative of the level of interest of the user in the item. In some implementations, updating the user interest record can include: including the data of the user interest record in one or more prompts to the one or more machine learning models; and receiving a recommended update to the weights of the user interest record from the one or more machine learning models. In some implementations, updating the user interest record can include updating, for each user interaction event with each displayed digital component, the weight for the item for which the digital component includes content. Updating the weight for the item for which the digital component includes content can include updating the weight by a different amount based on a type of the one or more user interaction events with the displayed digital component. In some implementations, updating the user interest record can include reducing, for each displayed digital component for which the user interaction event indicates that the user did not interact with the digital component, the weight for the item for which the digital component includes content.

Updating the user interest record can include adding one or more additional items to the set of items based on the one or more user interaction events.

Updating the user interest record can include removing an item from the set of items based on the user interaction event for a displayed digital component indicating that the user did not interact with the displayed digital component.

Aspects can include, during the user session, updating a positive user interest record based on the one or more user interaction events for a displayed digital component indicating that the user interacted with the displayed digital component, and updating a negative user interest record based on the user interaction event for a displayed digital component indicating that the user did not interact with the displayed digital component.

Aspects can include initiating a second user session with the conversational user interface; during the second user session: receiving, by the artificial intelligence system, one or more second prompts provided in the conversational user interface by a second user; displaying, in the conversational user interface, one or more second digital components that each include content related to a corresponding item based at least in part on the one or more second prompts; detecting, for each displayed second digital component, one or more second user interaction events indicative of whether the second user interacted with the second displayed digital component while the second digital component was displayed in the conversational user interface; updating an additional user interest record that includes data indicating a level of interest of the second user in a second set of items, wherein the level of interest for each item is determined by the one or more machine learning models based on the one or more second user interaction events for each second digital component, and wherein the second set of items includes the corresponding items of each second digital component; and updating the user interest record based on the additional user interest record. In some implementations, updating the user interest record can include adding one or more items from the second set of items to the set of items. In some implementations, the second user can be connected to the user in a social network. In some implementations, updating the user interest record can further include determining that the one or more second prompts are similar to the one or more prompts. In some implementations, updating the user interest record can further include determining that the one or more second user interaction events are similar to the one or more user interaction events.

Particular embodiments of the subject matter described in this specification can be implemented so as to realize one or more of the following advantages. The techniques described in this specification allow for digital components that are displayed in a conversational user interface of an artificial intelligence system to be tailored to a user's interests. For example, the techniques can include receiving prompts provided in the conversational user interface by a user and displaying digital components that include content based on the received prompts. When a user interacts with a displayed digital component, the techniques can further include updating a user interest record that includes data indicating a level of interest of the user in an item corresponding to the displayed digital component with which the user interacted. The techniques can then further tailor or customize additional digital components based on the user interest record and provide those to the user's device for display.

The techniques provide for a convenient and efficient user experience. For example, the techniques can tailor digital components to a user's interests without requiring the user to provide an explicit prompt describing their interests, which can be time-consuming and/or inconvenient.

The techniques can provide for a customized user experience over a longer period of time. For example, the techniques can include updating the user interest record based on contextual information such as user interactions (which can include non-interactions) with displayed digital components in a current user session. The techniques can also include updating the user interest record based on user interactions and prompts over the current user session as well as previous user sessions, and previous interactions with the artificial intelligence system and/or other systems. For example, the user interest record can be maintained and updated across multiple user sessions. The use of user interest data that has been refined over multiple user sessions increases the accuracy of the outputs (e.g., selected digital components, conversational responses, etc.) of the artificial intelligence system by adapting to a user's changing interests.

The techniques can provide for shared user experiences that provide for additional customization. For example, the techniques can include updating the user interest record of a first user to include data from the user interest record of a second user, if the prompts or the user interactions of the first user are similar to the prompts or the user interactions of the second user. Furthermore, a second user can share their user interest record with a first user. The user interest record of the first user can be updated to include data from the user interest record of the second user, so that the techniques can display digital components that are customized for the second user.

Using artificial intelligence to select and provide digital components based on data indicating a user's interest in items based on their interactions and/or non-interactions with digital components over one or more user sessions enables the system to provide more relevant information to the user, which gets the user to the information that the user is seeking faster, which results in fewer prompts by the user, fewer responses to such prompts, and reduces the number of web pages and/or other resources to which the user has to navigate to find relevant information. All of these things reduce computation burden placed on computing resources to transmit the prompts over a network, analyze the prompts to generate responses, and transmit resources over the network, which also reduces the amount of consumed bandwidth of the network and battery power of mobile devices of users submitting the prompts. This also reduces the number of inputs that need to be provided by a user, resulting in less time that the display of mobile devices are illuminated, which provides additional battery savings.

In some implementations, the system can constrain the size of the user interest records to reduce the size of prompts provided to machine learning models. This reduces the amount of processing that the artificial intelligence performs to generate a response to a prompt that includes the data of the user interest record. Absent these constraints, the amount of data can be large, resulting in delays in selecting and sending digital components to client devices, which is required to be performed in milliseconds. Delays in selecting and providing digital components can result in page load errors if content to be displayed on the page does not arrive in time. Additionally, constraining the size of prompts reduces the occurrences of and the magnitude of hallucinations in which the outputs of artificial intelligence models include false or misleading information. Thus, constraining the size of the prompts, e.g., by constraining the size of the user interest records, can prevent inaccurate and/or misleading digital components and/or conversational responses that are not relevant to a user's information needs, which reduces the number of prompts submitted by the user and processed by the artificial intelligence system.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which digital components are selected and displayed in a conversational user interface based on a user interest record.

FIG. 2 is a block diagram illustrating interactions between an artificial intelligence system and a client device.

FIG. 3 is a flow chart of an example process of selecting and displaying digital components in a conversational user interface based on a user interest record.

FIG. 4 is a flow chart of an example process for updating a user interest record for a user with data from another user interest record for another user.

FIG. 5 is a block diagram of an example computer.

Like reference numbers and designations in the various drawings indicate like elements.

### DETAILED DESCRIPTION

This specification describes techniques for enabling artificial intelligence to display responses and digital components in a conversational user interface that are tailored to the interests of a user of the conversational user interface. Artificial intelligence (AI) is a segment of computer science that focuses on the creation of intelligent agents that can learn and act autonomously (e.g., without human intervention). Artificial intelligence can utilize machine learning, which focuses on developing algorithms that can learn from data, natural language processing, which focuses on understanding and generating human language, and/or computer vision, which is a field that focuses on understanding and interpreting images and videos.

The techniques described throughout this specification enable AI to display digital components that are tailored to the interests of a user of the conversational user interface, where the interests of the user can be determined based on the user's interactions with the conversational user interface. For example, an AI system can display a digital component that includes content related to a corresponding item based on prompts provided in the conversational user interface by the user. The AI system can detect user interaction events indicative of whether the user interacted with the digital component and, if so, the type of interaction (e.g., selection, hover, etc.). The system can update a user interest record based on the user interaction events, and display additional digital components based on the data of the user interest record.

In some implementations, the system can utilize an input prompt to a language model, such as a large language model (LLM), that outputs multiple clauses to update the user interest record. The system uses the clauses to update the level of interest of the user in the set of items of the user interest record. The system then selects one or more items of the updated user interest record. For each selected item, the system can display an additional digital component which includes content related to the selected item.

The user interest record can be associated with a user. The user interest record can include data indicating a level of interest of the user in each item of a set of items. The user interest record can be updated during the user session, e.g., periodically or in response to events, e.g. presentation of content and/or interactions with the content. In some implementations, the user interest record can also be stored by the AI system 160 and maintained across multiple user sessions for the same user. In some implementations, the user interest record for a user can also be shared with other users. The AI system 160 can maintain a separate user interest record for multiple users. For example, the AI system 160 can maintain an individual user interest record for each user.

As discussed in more detail below, the prompt is specialized (e.g., created or augmented) to improve the overall relevance to the user's interests of the digital components that are displayed. For example, the prompt can include the data of a user interest record, e.g., data representing a set of items and/or data indicating a level of interest of the user in one or more items of the set of items. The prompt can also include data representing user interaction events.

Using the specialized prompt reduces wasted computing resources that would otherwise generate less relevant digital components if a more general prompt were used. Similarly, as discussed in more detail below, the number of digital components displayed to a user can be reduced, thereby saving computing resources and providing a user with a more efficient user experience, by using the specialized prompt to constrain the parameters used by the language model to generate responses. For example, by including the data of the user interest record and/or user interaction events in the prompt, the language model can constrain the size of the user interest record by not adding additional items to the set of items in the user interest record that are similar to items that have been displayed to the user in other digital components in which the user has not shown interest. Thus, the system can avoid the creation and/or display of digital components related to items that the user has not shown interest in, which reduces the time and computing resources required to generate and display the digital components. The system can also provide the user with digital components the user is more likely to be interested in, creating a more efficient user experience, and reducing the time and computing resources used to generate and update the conversational user interface.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

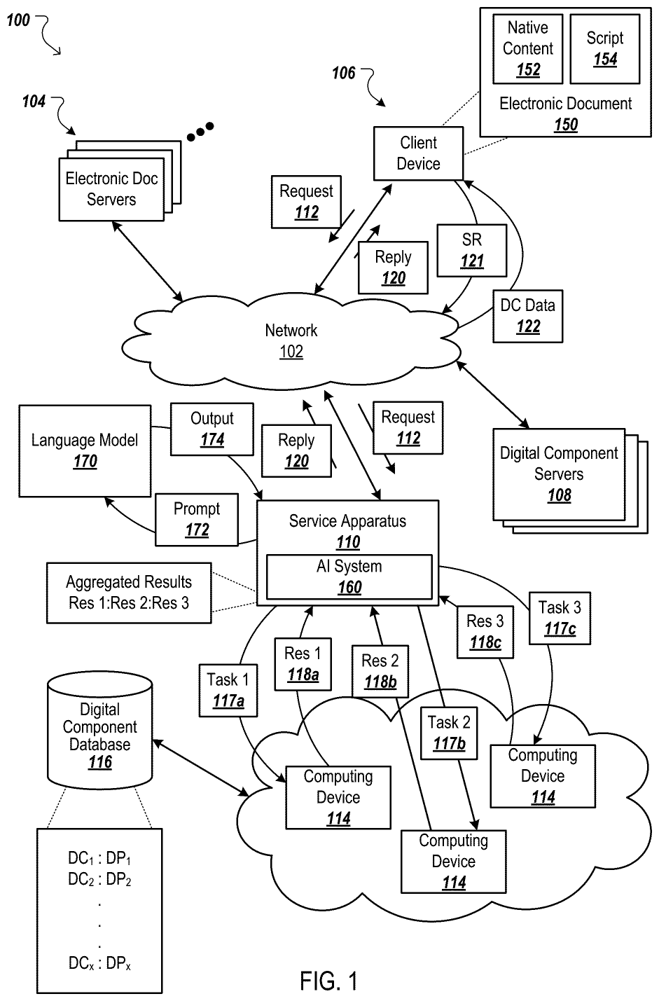

FIG. 1 is a block diagram of an example environment 100 in which digital components are selected and displayed in a conversational user interface based on a user interest record.

The example environment 100 includes a network 102, such as a local area network (LAN), a wide area network (WAN), the Internet, or a combination thereof. The network 102 connects electronic document servers 104, client devices 106, digital component servers 108, and a service apparatus 110. The example environment 100 may include many different electronic document servers 104, client devices 106, and digital component servers 108.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app, and communicate any user interactions with the user interface back to the cloud server for processing.

For example, the user interface can be a conversational user interface. A conversational user interface can be configured to allow one or more users of the client device 106 to communicate with other components of the environment 100 through natural language text, which can include text input by the user or text recognized from audio or video input. For example, the conversational user interface can be configured to allow a user to provide user prompts. The conversational user interface can display responses to user prompts. The response can include a conversational response such as a natural language text relevant to a user prompt, for example. The response can also include, for example, a digital component. In some examples, the response can include natural language text relevant to a user prompt and a digital component. The responses (or portions thereof) can be generated by other components of the environment 100 such as a language model 170. The conversational user interface can also be configured to allow a user to interact with responses that are displayed. For example, a user can respond to a response with another user prompt, or select (e.g., click on the response), hover over the response, pin the response to a user repository, save the response, remove the response from the user repository, etc. A hover can include a user placing a cursor or other pointer over the digital component, e.g., for at least a threshold period of time.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which the digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital components in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlayed over (or adjacent to) a portion of the native content 152 of the electronic document 150, and the service apparatus 110 can specify the presentation location within the electronic document 150 in the reply data 120. For example, when the native content 152 includes video content, the service apparatus 110 can specify a location or object within the scene depicted in the video content over which the digital component is to be presented.

The service apparatus 110 can also include an artificial intelligence system 160 configured to autonomously generate digital components, either prior to a request 112 (e.g., offline) and/or in response to a request 112 (e.g., online or real-time). As described in more detail throughout this specification, the artificial intelligence (“AI”) system 160 can collect online content about a specific entity (e.g., digital component provider or another entity) and summarize the collected online content using one or more language models 170, which can include large language models.

A large language model (“LLM”) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code.

A language model 170 can be any appropriate language model neural network that receives an input sequence made up of text tokens selected from a vocabulary and auto-regressively generates an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution, e.g., a probability distribution, that assigns a respective score, e.g., a respective probability, to each token in the vocabulary of tokens. The neural network of the language model 170 can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model 170 can be an auto-regressive Transformer-based neural network that includes (i) a plurality of attention blocks that each apply a self-attention operation and (ii) an output subnetwork that processes an output of the last attention block to generate the score distribution.

The language model 170 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J.W. Rac, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glacse, J. Welbl, S. Dathathri, S. Huang, J. Uesato, J. Mellor, I. Higgins, A. Creswell, N. McAleese, A.Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neclakantan, Pranav Shyam, Girish Sastry, Amanda Askell, et al. Language models are few-shot learners. arXiv preprint arXiv: 2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model 170 to generate multiple different candidate output sequences in response to the same request, e.g., by using beam search decoding from score distributions generated by the language model 170, using a Sample-and-Rank decoding strategy, by using different random seeds for the pseudo-random number generator that's used in sampling for different runs through the language model 170 or using another decoding strategy that leverages the auto-regressive nature of the language model.

In some implementations, the language model 170 is pre-trained, i.e., trained on a language modeling task that does not require providing evidence in response to user questions, and the service apparatus 110 (e.g., using AI system 160) causes the language model 170 to generate output sequences according to the pre-determined syntax through natural language prompts in the input sequence.

For example, the service apparatus 110 (e.g., AI system 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

In some implementations, the AI system 160 can generate a prompt 172 that is submitted to the one or more language models 170, and causes the one or more language models 170 to generate the output sequences 174, also referred to simply as “output”. The AI system 160 can generate the prompt in a manner (e.g., having a structure) that includes data of a user interest record. The prompt can include data representing user interaction events of a current user session with a conversational user interface. The prompt can include data representing user interaction events of a previous user session with the conversational user interface. The prompt can include data representing other information about the user associated with the user interest record. For example, the information can include information about the user, the user session, or of a particular user prompt. Other information can include, for example, a location of the client device 106 during the user session, or a time of day and a time of year of the user session or of a particular user prompt. The prompt can include any combination of data of the user interest record, data representing user interaction events, and/or other information.

To initiate creation of the output sequences 174, the AI system 160 submits the prompt 172 to the one or more language models 170, which evaluate the information specified in the prompt 172, and generate the output 174 that updates the user interest record based on the information specified in the prompt 172. For example, the output 174 can indicate that the user interest record should be updated and/or a recommended update to the user interest record. For example, the output 174 can indicate that the level of interest of the user in an item of the user interest record should be updated. In other examples, the output 174 can indicate that an item should be added to the list of items of the user interest record, or an item should be removed from the list of items of the user interest record.

Note that, although the operations of the AI system 160 and language model 170 are described above as being performed responsive to receipt of the request 112, at least some of the operations can be performed prior to receipt of the request 112.

Furthermore, although a single language model 170 is shown in FIG. 1, different language models can be specially trained to process different prompts at different stages of the user session. For example, a more general (e.g., larger) language model can be used to generate a user interest record at the beginning of a first user session, or to update an existing user interest record at the beginning of each user session. In another example, the larger language model can be used to update the user interest record at other points in time, e.g., during the user session. For example, the user interest record can be updated in a parallel process while the user interest record is not being used or while an older version of the user interest record is being used to generate responses. In this way, the user interest record can be more accurately updated without inducing latency into the system, e.g., without introducing latency in generating responses to prompts using user interest records. The data of the updated user interest record can be included in prompts that are input to more specialized and faster language models that are trained to be provide responses in milliseconds such that they can be used to select digital components in real time without slowing the selection process or causing errors in loading content at the client devices 106.

As an example, the AI system 160 can include separate language models. For example, the AI system 160 can include a language model for generating or updating user interest records, a language model for selecting digital components, and a language model for generating conversational responses. In some implementations, the same language model can be configured to generate or update user interest records, select digital components, and/or generate conversational responses.

The AI system 160 can also store the data of user interest records of multiple users. When the AI system 160 receives a component request 112, the AI system 160 can select items from the set of items of the user interest record for including for display in digital components from the database. In some implementations, the AI system 160 can use a model to select digital components corresponding to the selected items to display. For example, the model can be a machine learning model trained to select digital components corresponding to given selected items. The machine learning model can be trained to select digital components based on data from a user interest record. For example, the AI system 160 can provide the data of the user interest record to the machine learning model. The machine learning model can be configured, e.g., trained, to select digital components from the database of digital components. As an example, the AI system 160 can include data of the user interest record in the component request 112 to the service apparatus 110.

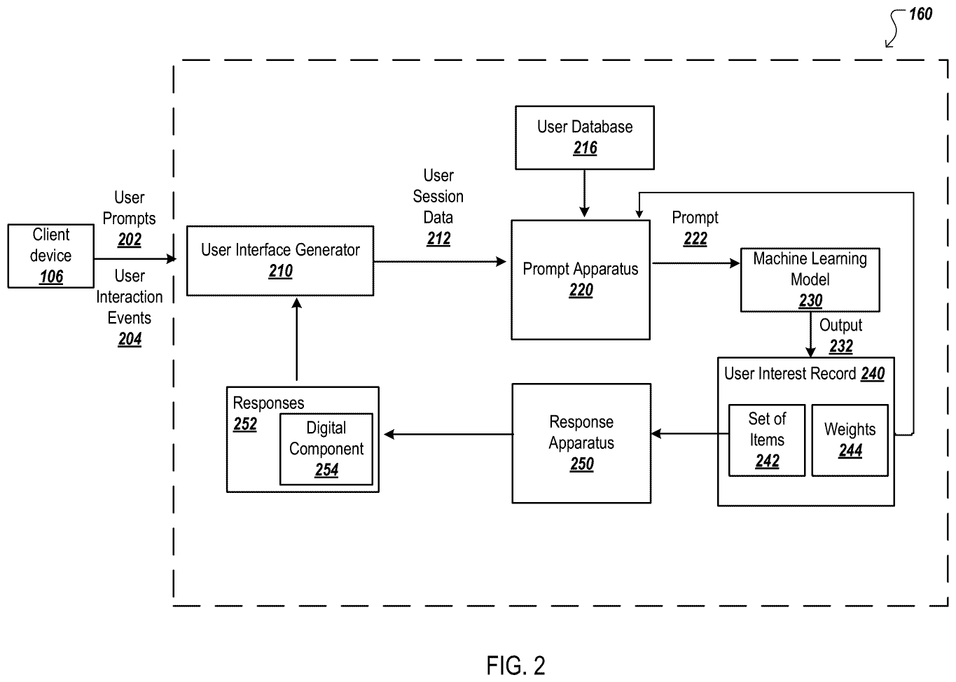

FIG. 2 is a block diagram 200 illustrating interactions between an AI system 160 and a client device 106. The AI system 160 can include a user interface generator 210, a prompt apparatus 220, a user database 216, a machine learning model 230, a user interest record 240, and a response apparatus 250. Although the diagram 200 shows one user interest record 240, the AI system 160 can include multiple user interest records. For example, the AI system 160 can include a user interest record for each user, or multiple user interest records for each user.

A user of the client device 106 can interact with the AI system 160 through a conversational user interface on the client device 106. For example, the conversational user interface can be displayed at the client device 106. During a user session, the user can interact with contents of the conversational user interface by speaking, typing, or using a pointer, for example.

A user session may begin when a user navigates to the conversational user interface. For example, a user can navigate to the web page that includes the conversational user interface, or open an application that includes the conversational user interface. A user session may also begin upon a user's first interaction with the conversational user interface, or upon a first prompt input by the user. A user session may end when a user navigates away from the conversational user interface. For example, the user can leave the web page that includes the conversational user interface, or close the application that includes the conversational user interface. A user session may also end when there have been no interactions with the conversational user interface for a specified duration of time.

The conversational user interface can be configured to allow a user to provide user prompts 202. For example, the conversational user interface can allow a user to type a user prompt 202 of natural language text. The conversational user interface can also display responses 252 to user prompts 202. A response 252 can include, for example, natural language text that is relevant to the user prompt 202, and/or a digital component 254.

The conversational user interface can also allow a user to interact with responses 252. The conversational user interface can detect user interaction events 204 for responses 252, or for content of responses 252. For example, the response 252 can include a digital component 254 that includes content related to a corresponding item. A user interaction event 204 can indicate whether a user interacted with a displayed digital component 254 while the digital component 254 was displayed in the conversational user interface. A user interaction event 204 can also indicate the type of the user interaction and/or the duration of the user interaction. If the user interaction included a selection of the digital component, which caused the client device 106 to navigate to an electronic document, the user interaction event can indicate a duration of time that the user spent at the electronic document. For example, if selection of the digital component caused the client device 106 to display a web page linked to by the digital component and the user viewed the web page for two minutes, the user interaction event 204 can include data indicating a view time of two minutes for the user selection of the digital component. The user interaction event 204 can also indicate that the user did not interact with a displayed digital component 254 if the user did not interact with the displayed digital component 254.

A user can respond to a response 252 with another user prompt 202. A user can also interact with the response 252 using a pointer. Other examples of user interaction events 204 can include when the user clicks on content of the response, hovers over content of the response, pins content of the response, saves content of the response, or performs other actions with content of the response. Other examples include viewing or watching content of the response, for example, if the content of the response includes a video. For example, if the user watched a video of the response for two minutes, the user interaction event 204 can include data indicating a view time of two minutes for the video. The user interaction events 204 can thus be used to indicate user interest in the response. The user interaction events 204 can also be used to indicate a level of user interest in the response.

The conversational user interface can be updated by the AI system 160. For example, the AI system 160 can use the user interface generator 210 to generate and update user interfaces that are displayed at the client device 106. For example, the user interface generator 210 can update the conversational user interface. The user interface generator 210 can also receive updates from the user through the conversational user interface. That is, the user interface generator 210 can receive user prompts 202 and user interaction events 204 through the conversational user interface.

The AI system 160 can provide the user prompts 202 and the user interaction events 204 as user session data 212 to the prompt apparatus 220. The prompt apparatus 220 can be configured to generate a prompt 222 for the machine learning model 230 that includes user session data 212. For example, during a user session, the user session data 212 can include at least some or all of the user prompts 202 and user interaction events 204 for the user session. The prompt 222 can thus include data representing the user prompts 202 and user interaction events 204. In some implementations, the prompt apparatus 220 can generate the prompt 222 to include other data about the user, such as information related to user session data from previous user sessions, or data representing other information about the user. Other information can include, for example, a location of the client device, a type of client device, a time of day, a month of year, etc. For example, the prompt apparatus 220 can obtain previous user session data or data representing other information about the user from the user database 216. Other information can include places of interest for the user, previous purchases by the user, and/or user profile information, for example.

In some implementations, the AI system 160 can run at least the prompt apparatus 220 and the machine learning model 230 in a secure and/or isolated environment to protect user privacy. For example, the AI system 160 can include a Trusted Execution Environment (TEE) in which the machine learning model 230 is executed. A TEE can manage the data that is provided to and sent from the TEE. This can prevent sensitive user data that is used by the machine learning model 230 from being accessible outside of this secure environment.

In some implementations, the prompt apparatus 220 can perform embedding to generate a prompt 222 that includes embedded data. For example, the prompt 222 can include different types of data such as text, images, and/or video.

In some examples, the prompt apparatus 220 can include the data of the user interest record 240 for the user in the prompt 222. For example, for a user that has an existing user interest record 240 (which can include data across multiple user sessions of the user), or existing user interest record 240 for the user session, the prompt apparatus 220 can include the data of the user interest record 240 in the prompt 222. In some implementations, the prompt apparatus 220 can embed the data of the user interest record 240 for inclusion in the prompt 222, or constrain the size of the prompt 222.

The AI system 160 can provide the prompt 222 to the machine learning model 230. The machine learning model 230 can include the one or more language models 170 described above with reference to FIG. 1. Other types of machine learning models can also be used. The machine learning model 230 can generate an output 232 based on the prompt 222.

In some examples, the machine learning model 230 can be trained to output updates to a user interest record 240 based on the prompt 222. The prompt 222 can include, for example, a user prompt 202, other information, user interaction events 204, and/or an existing user interest record 240. The machine learning model 230 can process the prompt 222 to generate an output 232 that includes an update to the user interest record 240. The output 232 can include an item, for example, that the AI system 160 can include in an existing user interest record 240. The output 232 can also be a user interest record 240, for example, for a first user session of a user, or upon receiving a first prompt in a current user session, if the AI system 160 does not have an existing user interest record 240 for the user. The output 232 can also include updates to weights of the user interest record 240, for example.

In some examples, the machine learning model 230 can be trained to output natural language text relevant to the prompt 222. The prompt 222 can include, for example, a user prompt 202, other information, user interaction events 204, and/or an existing user interest record 240. The machine learning model 230 can process the prompt 222 to generate an output 232 that includes natural language text relevant to the prompt 222. The output 232 can include, for example, a conversational response.

In some implementations, the AI system 160 can use the machine learning model 230 to invoke another program, such as an application programming interface (API). For example, the AI system 160 can provide a path or location of a user interest record 240 as part of the prompt 222 and use the machine learning model 230 to invoke another program to access the data of the user interest record 240.

The user interest record 240 can include data representing a set of items 242. For example, an item can be a product, a service, or an experience. Each item can be associated with attributes. For example, a product that is a set of earrings can be associated with attributes such as material, color, cost, shape, etc. One or more items in the set of items 242 can be associated with one or more digital components 254 that include content related to the item(s). The user interest record 240 can also include data indicating a level of interest of the user in each item in the set of items 242. For example, the user interest record 240 can include weights 244 to indicate a level of interest of the user in each item in the set of items 242. That is, the user interest record 240 can include, for each item, a corresponding weight that indicates the user's current level of interest in the item. The level of interest can be determined using the machine learning model 230, for example, based on the user interaction events 204. For example, the prompt 222 can include a request to generate weights that indicate a level of interest of the user in a set of items.

A higher weight can indicate a higher level of interest, for example. A lower weight can indicate a lower level of interest. In some implementations, a higher weight can indicate a lower level of interest and a lower weight can indicate a higher level of interest. In some implementations, the weights can include a sign and a magnitude. For example, a positive weight can indicate a positive level of interest. A higher positive weight can indicate a higher level of interest than a lower positive weight. A negative weight can indicate a negative level of interest. A negative weight with a larger magnitude can indicate a lower level of interest than a negative weight with a smaller magnitude.

In some implementations, a size of the user interest record 240 can be constrained. For example, the AI system 160 can include a maximum number of items for the set of items 242 that are represented by each user interest record 240. In these implementations, the user interest record 240 can include, in addition to weights or in place of weights, a ranking for each item in the set of items 242 that indicates a relative level of interest of the user in each item. When the set of items 242 reaches the maximum number of items, the AI system 160 can remove the lowest-ranking items (or lowest weighted items) before adding new items to the set of items 242. In some implementations, a data size of the user interest record 240 can be constrained. For example, the AI system 160 can include a maximum data size for the user interest record 240.

In some implementations, the user interest record 240 for a user can be maintained across multiple user sessions of the user. The AI system 160 can update the user interest record 240 for the user during each of the user sessions of the user. For example, the AI system 160 can store data representing the user interest record 240 in a database of user interest records. When a user begins a new user session, the AI system 160 can identify in the database whether the user has an existing user interest record 240. The AI system 160 can access the user interest record 240 and update the user interest record 240 for the user. If the user does not have an existing user interest record 240, the AI system 160 can create a user interest record 240 for the user and store data representing the user interest record 240 in the database.

In some examples, the output 232 can indicate that the data of an existing user interest record 240 should be updated. For example, the existing user interest record 240 can have been output from the machine learning model 230 during a previous user session, or in response to a previous prompt in a current user session. The output 232 can include updates to the set of items 242 of the user interest record 240. For example, the output 232 can indicate that one or more additional items should be added to the set of items 242. The machine learning model 230 can determine that additional items should be added to the set of items 242 based on the user interaction events 204, for example. The additional items can include items with attributes specified by the machine learning model 230, for example. The additional items can include items that have certain similar attributes as items in the set of items 242. The AI system 160 can obtain items with the desired attributes from an item database that includes data representing different items, for example. As an example, if the user interaction events indicate that the user saved or pinned multiple digital components displaying silver earrings, the machine learning model 230 can determine that the user prefers or is otherwise interested in silver earrings. The AI system 160 can thus add data representing a pair of silver earrings to the set of items 242.

The output 232 can also indicate that some of the set of items 242 should be removed from the set of items 242. The machine learning model 230 can determine that items should be removed from the set of items 242 based on a type of user interaction event, or a lack of user interaction events 204. In the example of earrings, if a user interaction event indicates that the user removed a digital component displaying gold earrings, or did not interact with digital components displaying gold earrings, the machine learning model 230 can determine that the user does not prefer gold earrings. The AI system 160 can thus remove items that are gold earrings from the set of items 242.

In some implementations, the AI system 160 can include a positive user interest record and a negative user interest record for each user. For example, the positive user interest record can include the set of items and their associated weights in which the AI system 160 has determined the user has a positive level of interest. The negative user interest record can include the set of items and their associated weights in which the AI system 160 has determined that the user has a negative level of interest or no interest.

The AI system 160 can update one or both of the positive user interest record or the negative user interest record upon receiving a user prompt 202 or detecting a user interaction event 204 in similar ways that the user interest record 240 is updated. For example, the AI system 160 can update the positive user interest record to include an additional item, or increase or decrease the weight of an item, based on the one or more user interaction events for a displayed digital component. The AI system can update the negative user interest record to include an additional item, or increase or decrease the weight of an item, based on the user interaction event for a displayed digital component indicating that the user did not interact with the displayed digital component.

The output 232 can also include updates to the weights 244 of the user interest record 240. The machine learning model 230 can determine updates to the weights 244 based on the user interaction events 204, for example. As an example, if a user interaction event 204 for a digital component that includes content related to a corresponding item includes a user interaction that indicates positive interest, such as clicking, hovering, or saving, the weight for the corresponding item can be increased. For example, if a user pins multiple digital components that include content related to silver earrings, the weights corresponding to those silver earrings can be increased. In some implementations, the weights of related items can be increased. For example, the weights corresponding to silver-colored earrings or platinum earrings can be increased.

As another example, if a user interaction event 204 for a digital component that includes content related to a corresponding item includes a user interaction that indicates disinterest, such as removing the digital component, the weight for the corresponding item can be decreased. If no user interaction events 204 are detected for a digital component, the weight for the corresponding items can also be decreased.

In some implementations, the amount by which a weight in weights 244 is increased or decreased can differ. For example, the amount by which a weight is updated can be based on a type of the associated user interaction event 204. Different types of user interaction events 204 can be associated with different levels of user interest. For example, the weight for an item whose associated user interaction event was removing the digital component can be decreased by a larger amount than the weight for an item that did not have an associated user interaction event. As another example, the weight for an item whose associated user interaction event was a click can be increased by a larger amount than the weight for an item whose associated user interaction event was a hover.

For example, a selection or click on a digital component can indicate a higher level of user interest in the item of the digital component than a hover over the digital component. Thus the weight for the item can be increased by a larger amount if the user interaction event indicates a click than if the user interaction event indicates a hover.

As another example, a pin or save on a digital component can indicate a higher level of user interest than a click or a hover over the digital component. Thus, the weight for the item can be increased by a larger amount if the user interaction event indicates a pin or a save than if the user interaction event indicates a click or a hover.

As another example, a longer duration spent on an electronic document linked to by the digital component can indicate a higher level of user interest in the item of the digital component, than a shorter duration spent on the electronic document. For example, the weight for an item of the digital component can be increased by a larger amount for a longer duration.

As another example, a longer duration spent watching a video of the digital component can indicate a higher level of user interest in the item of the digital component, than a shorter duration spent watching the video. For example, the weight for an item of the digital component can be increased by a larger amount for a longer duration.

As another example, removing the digital component can indicate a lower level of user interest than no interaction with the digital component. Thus, the weight for the item can be decreased by a larger amount if the user interaction event indicates a removal than if the user interaction event indicates the user did not interact with the digital component.

In some implementations, the AI system 160 can update the user interest record 240 upon receiving a new user prompt 202 or detecting a new user interaction event 204. In some implementations, the AI system 160 can update the user interest record 240 multiple times for every new user prompt 202. For example, the AI system 160 may detect multiple user interaction events 204 in between user prompts 202.

In some implementations, items in the set of items 242 can include features or characteristics of items. For example, an item can be a color of a product or a type of flavor of food. These items that represent features or characteristics of items can be added and/or removed, and the weights can be determined in a similar manner at other items. For example, if a user interacts with many cars having a particular color, the user interest record 240 can be updated to include that color and the weight for that color can be increased.

The response apparatus 250 can generate responses 252 to user prompts 202. The response apparatus 250 can generate responses 252 using a machine learning model, for example. A response 252 can include a digital component 254. The AI system 160 can display digital components 254 in the conversational user interface based on the user interest record 240. For example, the AI system 160 can use the response apparatus 250 to select one or more items in the set of items 242 that are of interest to the user. For example, the response apparatus 250 can select a certain number of items with the highest weights or rankings of the user's interest. In some implementations, the response apparatus 250 can select or generate an additional digital component 254 for each of the selected items, for example, by searching an index of a digital component database for the selected item or using a generative AI model (e.g., an LLM) to generate a digital component based on characteristics of the item. The response apparatus 250 can also generate content of the additional digital component 254. For example, the response apparatus 250 can determine links for each of the selected items.

In implementations where the AI system 160 includes a positive user interest record and a negative user interest record for each user, the AI system 160 can display digital components 254 in the conversational user interface based on the positive user interest record. For example, the AI system 160 can use the response apparatus 250 to select one or more items in the positive user interest record. In such examples, the AI system 160 can use the negative user interest record to filter digital components for items in the negative user interest record from a set of candidate digital components.

The AI system 160 can thus display the additional digital components 254 in the conversational user interface based on the user interest record 240. The AI system 160 can continue updating the user interest record 240 for the user during the user session based on user interaction events with the additional digital components 254. For example, the AI system 160 can use the conversational user interface to detect user interaction events indicative of whether the user interacted with the displayed additional digital components 254, and update the user interest record as described above. Thus, a first set of additional digital components 254 may not be as tailored to a user's interests, but as the AI system 160 obtains more information through the conversational user interface, the additional digital components 254 can become more tailored to the user.

In some implementations, the user interest record 240 can be stored for later use by the AI system 160. In some implementations, the AI system 160 can include one or more user interest records 240 for each user of the conversational user interface. In some implementations, the AI system 160 can obtain permission from a user, and share the user interest record 240 with other users, or use the user interest record 240 to update the user interest records of other users. In some implementations, after sharing the user interest record 240 with a second user, the AI system 160 can provide the contents of the user interest record for viewing by the second user. For example, the AI system 160 can provide some of the set of items for display to the second user through the conversational user interface. The second user can select some of the displayed items to add to their own user interest record. The AI system 160 can thus update the user interest record of the second user based on the user interest record 240.

In some implementations, the AI system 160 can access the user interest record 240 periodically to provide updates to the user related to items in the set of items 242. For example, the AI system 160 can provide a notification to the user about a change in price or availability for an item included in the set of items 242, for example.

In some implementations, the AI system 160 can initiate a second user session with a second user. The AI system 160 can generate and update an additional user interest record for the second user as described above. The AI system 160 can then update the user interest record based on the additional user interest record. For example, the user associated with the user interest record may be looking for gifts for the second user associated with the additional user interest record. In some implementations, the second user may be connected to the user, for example, as users of the same conversational user interface who have established a connection on a platform. For example, the second user may be connected to the user through a social network. After receiving permission from the second user to share the additional user interest record, the AI system 160 can update the user interest record based on the additional user interest record. For example, the AI system 160 can add items from the set of items of the additional user interest record to the set of items 242 of the user interest record 240. The AI system 160 can remove items from the set of items 242 of the user interest record 240 that are not present in the set of items of the additional user interest record. The AI system can also update the additional user interest record based on the user interest record 240.

In some implementations, the AI system 160 can update the user interest record 240 based on the additional user interest record, or update the additional user interest record based on the user interest record 240. The AI system 160 can update the user interest record of one user to include items from the user interest record of another user upon determining that the users are similar, or have had similar journeys. For example, similar journeys can include similar user interaction events or conversations with the AI system 160.

The AI system 160 can determine that users are similar using a language model, for example. For example, the language model can be configured to determine a measure of similarity between two users based on information about the two users. For example, the information about the two users can include user prompts or user interaction events. The AI system 160 can provide the language model with information about at least two users. The language model can determine a measure of similarity between each user and each other user. The AI system 160 can determine that users are similar if their measure of similarity is over a threshold measure of similarity, for example.

In some implementations, the AI system 160 can update the user interest record 240 based on the additional user interest record after determining that the user and the second user have provided similar user prompts. During the user session, the AI system 160 can search the user database 216 for user session data that includes similar user prompts. For example, if the user and the second user have provided similar user prompts, they may be more likely to be interested in similar items or types of items at similar points in the user session. The AI system 160 can use a machine learning model, for example, to determine whether user prompts are similar.

In some implementations, the AI system 160 can update the user interest record 240 based on the additional user interest record after determining that the user interaction events of the second user are similar to the user interaction events 204 of the user. During the user session, the AI system 160 can search the user database 216 for user session data that includes similar user interactions. For example, if the user and the second user have similar user interaction events, such as interacting in similar ways to similar digital components, they may be more likely to be interested in similar items. The AI system 160 can use a machine learning model, for example, to determine whether user interaction events are similar.

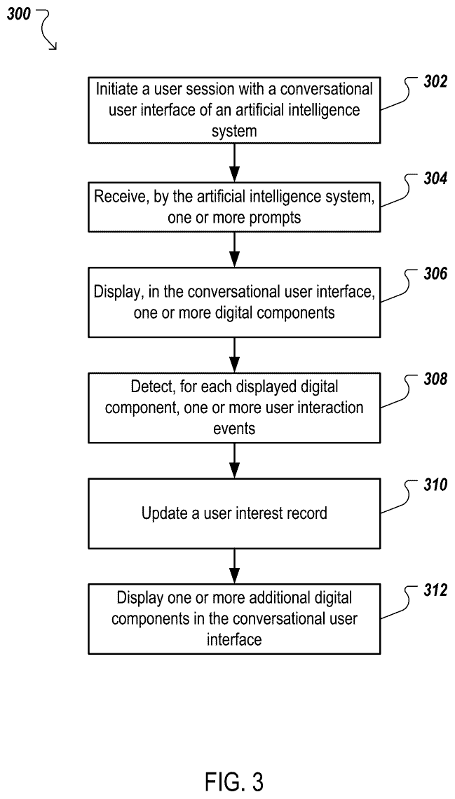

FIG. 3 is a flow chart of an example process 300 for selecting and displaying digital components in a conversational user interface based on a user interest record. Operations of the process 300 can be performed, for example, by the service apparatus 110 of FIG. 1, or another data processing apparatus. The operations of the process 300 can also be implemented as instructions stored on a computer readable medium, which can be non-transitory. Execution of the instructions, by one or more data processing apparatus, causes the one or more data processing apparatus to perform operations of the process 300.

A user session with a conversational user interface of an artificial intelligence system is initiated (302). The artificial intelligence system displays, within the conversational user interface, responses to user prompts received during the user session. The responses can be generated using one or more machine learning models of the artificial intelligence system. For example, the one or more machine learning models can include a language model.

During the user session, one or more prompts are received by the artificial intelligence system (304). The prompts can be provided in the conversational user interface by a user. For example, the prompts can include natural language text. The prompts can be input to the conversational user interface through typing, or through the transcription of an audio or video recording.

During the user session, one or more user digital components are displayed in the conversational user interface (306). The one or more digital components can each include content related to a corresponding item based at least in part on the one or more prompts. For example, the digital components can be selected or generated by the one or more machine learning models.

During the user session, one or more user interaction events can be detected for each displayed digital component (308). The one or more user interaction events can be indicative of whether the user interacted with the displayed digital component while the digital component was displayed in the conversational user interface. User interaction events can include, for example, pins, stars, clicks, hovers, or removals. Other types of interactions can also be included.

During the user session, a user interest record can be updated (310). The user interest record can include data indicating a level of interest of the user in a set of items. The set of items can include the corresponding items of each digital component. In some implementations, updating the user interest record can include adding the data of the user interest record to one or more prompts to the one or more machine learning models and receiving a recommended update to the user interest record from the one or more machine learning models. For example, the recommended update can include an additional item, a removed item, or updated weights. In implementations where the data indicating a level of interest of the user in a set of items includes a weight for each item, updating the user interest record can include adding the data of the user interest record to one or more prompts to the one or more machine learning models and receiving a recommended update to the weights from the one or more machine learning models.

The level of interest can be determined by the one or more machine learning models based on the one or more user interaction events for each digital component. In some implementations, the level of interest can be further based on information related to one or more previous user sessions of the user with the artificial intelligence system. For example, the information can be included in the prompt to the one or more machine learning models. Other information can include, for example, an existing user interest record, or a location of the client device, a type of the client device, a time of day, a time of year, etc.

In some implementations, the data indicating a level of interest of the user in a set of items can include a weight for each item in the set of items. Each weight can be indicative of the level of interest of the user in the corresponding item. In these implementations, updating the user interest record can include updating, for each user interaction event with each displayed digital component, the weight corresponding to the item corresponding to the digital component. Updating the weight corresponding to the item corresponding to the digital component can include updating the weight by a different amount based on a type of the one or more user interaction events with the displayed digital component.

Updating the user interest record can include adding one or more additional items to the set of items based on the one or more user interaction events. Updating the user interest record can also include removing one or more items from the set of items based on the one or more user interaction events, or based on the user interaction event for a displayed digital component indicating that the user did not interact with the displayed digital component.

In some implementations, updating the user interest record can include updating a positive user interest record based on the one or more user interaction events for a displayed digital component indicating that the user interacted with the displayed digital component, and updating a negative user interest record based on the user interaction event for a displayed digital component indicating that the user did not interact with the displayed digital component.

In some implementations, the user interest record can be maintained across multiple user sessions. The same user interest record can be updated during each user session of the multiple user sessions for the same user.

In some implementations, a size of the user interest record can be constrained. For example, the set of items can be limited to a certain number of items.

During the user session, one or more additional digital components can be displayed in the conversational user interface (312). The one or more additional digital components can be displayed based at least in part on the user interest record. Displaying the one or more additional digital components can include providing the data of the user interest record to the artificial intelligence system. For example, the artificial intelligence system can generate or obtain contents for digital components that correspond to items in the user interest record. The artificial intelligence system can also select items in the user interest record to display digital components for.

In some implementations, one or more user interaction events can be detected for each additional displayed digital component. The one or more user interaction events can be indicative of whether the user interacted with the displayed additional digital component while the additional digital component was displayed in the conversational user interface. The user interest record can be updated based on the one or more interaction events for each additional digital component, using steps 306 to 312 of the process 300.

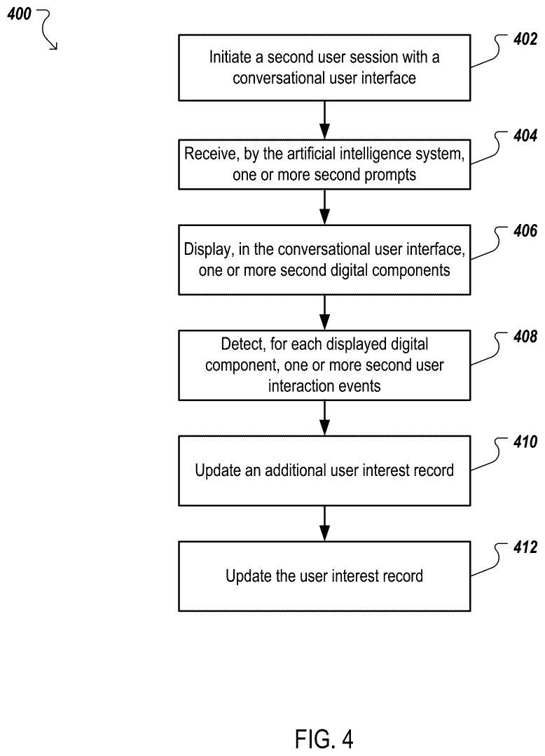

FIG. 4 is a flow chart of an example process 400 for updating a user interest record for a user with data from another user interest record for another user. Operations of the process 400 can be performed, for example, by the service apparatus 110 of FIG. 1, or another data processing apparatus. The operations of the process 400 can also be implemented as instructions stored on a computer readable medium, which can be non-transitory. Execution of the instructions, by one or more data processing apparatus, causes the one or more data processing apparatus to perform operations of the process 400. The operations of the process 400 can be performed with the operations of process 300. For example, the operations of the process 400 can be performed before or in parallel with the operations of process 300.

A second user session with the conversational user interface can be initiated (402). The second user session is similar to the user session, but with a different user than the user of the user session.

During the second user session, one or more second prompts can be received by the artificial intelligence system (404). The one or more second prompts can be provided in the conversational user interface by a second user. In some implementations, the second user is connected to the user. For example, the second user can be connected to the user through a communication or social platform.

During the second user session, one or more second digital components can be displayed in the conversational user interface (406). The one or more second digital components can each include content related to a corresponding item based at least in part on the one or more second prompts.

During the second user session, one or more second user interaction events can be detected for each displayed second digital component (408). The second user interaction events can be indicative of whether the second user interacted with the second displayed digital component while the second digital component was displayed in the conversational user interface.

During the second user session, an additional user interest record can be updated (410). The additional user interest record can include data indicating a level of interest of the second user in a second set of items. The second set of items can include the corresponding items of each second digital component. The level of interest for each item can be determined by the one or more machine learning models based on the one or more second user interaction events for each second digital component.

The user interest record can be updated based on the additional user interest record (412). For example, the user interest record can be updated during the second user session, or after the second user session has ended. In some implementations, the additional user interest record can similarly be updated based on the user interest record.

In some implementations, updating the user interest record can further include determining that the one or more second prompts are similar to the one or more prompts. In some implementations, updating the user interest record can further include determining that the one or more second user interaction events are similar to the one or more user interaction events. For example, a machine learning model can be used to determine similarity between prompts or user interaction events.

In some implementations, updating the user interest record can include adding one or more items from the second set of items to the set of items. Updating the user interest record can also include removing one or more items that are not in the second set of items from the first set of items.

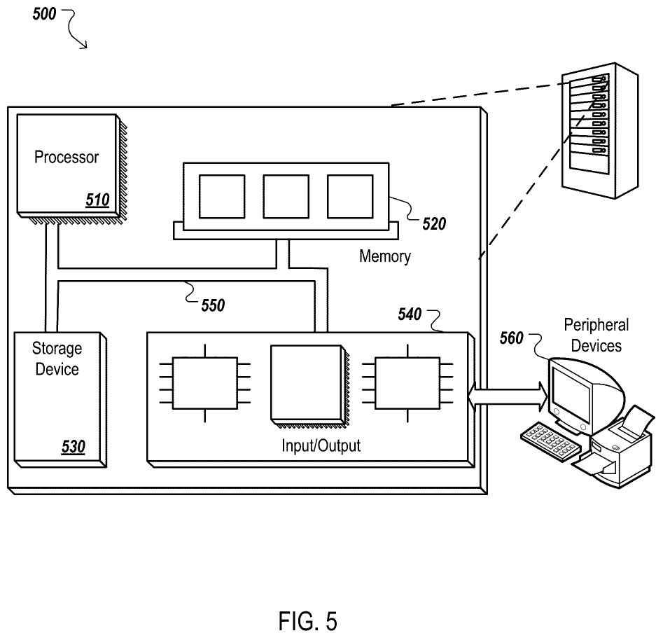

FIG. 5 is a block diagram of an example computer system 500 that can be used to perform operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 560. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method, comprising:
initiating a user session with a conversational user interface of an artificial intelligence system that displays, within the conversational user interface, responses to user prompts received during the user session, the responses being generated using one or more machine learning models of the artificial intelligence system;
during the user session:
receiving, by the artificial intelligence system, one or more prompts provided in the conversational user interface by a user;
displaying, in the conversational user interface, one or more digital components that each include content related to a corresponding item based at least in part on the one or more prompts;
detecting, for each displayed digital component, one or more user interaction events indicative of whether the user interacted with the displayed digital component while the digital component was displayed in the conversational user interface;
updating a user interest record that includes data indicating a level of interest of the user in a set of items, wherein the level of interest for each item is determined by the one or more machine learning models based on the one or more user interaction events for each digital component; and
displaying one or more additional digital components in the conversational user interface based at least in part on the user interest record.

2. The method of claim 1, wherein the level of interest for each item determined by the one or more machine learning models is further based on information related to one or more previous user sessions of the user with the artificial intelligence system.

3. The method of claim 1, wherein updating the user interest record comprises:
including the data of the user interest record in one or more prompts to the one or more machine learning models; and
receiving a recommended update to the user interest record from the one or more machine learning models.

4. The method of claim 1, wherein displaying one or more additional digital components in the conversational user interface comprises providing the data of the user interest record with a request for a digital component to the artificial intelligence system.

5. The method of claim 1, wherein the user interest record is maintained across a plurality of user sessions, and wherein the user interest record is updated during each user session of the plurality of user sessions.

6. The method of claim 1, further comprising constraining a data size of the user interest record.

7. The method of claim 1, further comprising, after displaying the one or more additional digital components in the conversational user interface:
detecting, for each additional displayed digital component, one or more user interaction events indicative of whether the user interacted with the displayed additional digital component while the additional digital component was displayed in the conversational user interface; and
updating the user interest record based on the one or more user interaction events for each additional digital component.

8. The method of claim 1, wherein data indicating a level of interest of the user in a set of items comprises a weight for each item in the set of items, wherein the weight for each item is indicative of the level of interest of the user in the item.

9. The method of claim 8, wherein updating the user interest record comprises:
including the data of the user interest record in one or more prompts to the one or more machine learning models; and
receiving a recommended update to the weights of the user interest record from the one or more machine learning models.

10. The method of claim 8, wherein updating the user interest record comprises updating, for each user interaction event with each displayed digital component, the weight for the item for which the digital component includes content.

11. The method of claim 10, wherein updating the weight for the item for which the digital component includes content comprises updating the weight by a different amount based on a type of the one or more user interaction events with the displayed digital component.

12. The method of claim 8, wherein updating the user interest record comprises reducing, for each displayed digital component for which the user interaction event indicates that the user did not interact with the digital component, the weight for the item for which the digital component includes content.

13. The method of claim 1, wherein updating the user interest record comprises adding one or more additional items to the set of items based on the one or more user interaction events.

14. The method of claim 1, wherein updating the user interest record comprises removing an item from the set of items based on the user interaction event for a displayed digital component indicating that the user did not interact with the displayed digital component.

15. The method of claim 1, further comprising, during the user session, updating a positive user interest record based on the one or more user interaction events for a displayed digital component indicating that the user interacted with the displayed digital component, and updating a negative user interest record based on the user interaction event for a displayed digital component indicating that the user did not interact with the displayed digital component.

16. The method of claim 1, wherein the method further comprises:
initiating a second user session with the conversational user interface;
during the second user session:
receiving, by the artificial intelligence system, one or more second prompts provided in the conversational user interface by a second user;
displaying, in the conversational user interface, one or more second digital components that each include content related to a corresponding item based at least in part on the one or more second prompts;
detecting, for each displayed second digital component, one or more second user interaction events indicative of whether the second user interacted with the second displayed digital component while the second digital component was displayed in the conversational user interface;
updating an additional user interest record that includes data indicating a level of interest of the second user in a second set of items, wherein the level of interest for each item is determined by the one or more machine learning models based on the one or more second user interaction events for each second digital component, and wherein the second set of items includes the corresponding items of each second digital component; and
updating the user interest record based on the additional user interest record.

17. The method of claim 16, wherein updating the user interest record comprises adding one or more items from the second set of items to the set of items.

18. The method of claim 16, wherein the second user is connected to the user in a social network.

19. The method of claim 16, wherein updating the user interest record further comprises determining that the one or more second prompts are similar to the one or more prompts.

20. The method of claim 16, wherein updating the user interest record further comprises determining that the one or more second user interaction events are similar to the one or more user interaction events.

21. A system comprising:
one or more processors; and
one or more storage devices storing instructions that, when executed by the one or more processors, cause the one or more processors to carry out operations comprising:
initiating a user session with a conversational user interface of an artificial intelligence system that displays, within the conversational user interface, responses to user prompts received during the user session, the responses being generated using one or more machine learning models of the artificial intelligence system;
during the user session:
receiving, by the artificial intelligence system, one or more prompts provided in the conversational user interface by a user;
displaying, in the conversational user interface, one or more digital components that each include content related to a corresponding item based at least in part on the one or more prompts;
detecting, for each displayed digital component, one or more user interaction events indicative of whether the user interacted with the displayed digital component while the digital component was displayed in the conversational user interface;
updating a user interest record that includes data indicating a level of interest of the user in a set of items, wherein the level of interest for each item is determined by the one or more machine learning models based on the one or more user interaction events for each digital component; and
displaying one or more additional digital components in the conversational user interface based at least in part on the user interest record.

22. A non-transitory computer readable storage medium carrying instructions that, when executed by one or more processors, cause the one or more processors to perform operations comprising:
initiating a user session with a conversational user interface of an artificial intelligence system that displays, within the conversational user interface, responses to user prompts received during the user session, the responses being generated using one or more machine learning models of the artificial intelligence system;
during the user session:
receiving, by the artificial intelligence system, one or more prompts provided in the conversational user interface by a user;
displaying, in the conversational user interface, one or more digital components that each include content related to a corresponding item based at least in part on the one or more prompts;
detecting, for each displayed digital component, one or more user interaction events indicative of whether the user interacted with the displayed digital component while the digital component was displayed in the conversational user interface;
updating a user interest record that includes data indicating a level of interest of the user in a set of items, wherein the level of interest for each item is determined by the one or more machine learning models based on the one or more user interaction events for each digital component; and
displaying one or more additional digital components in the conversational user interface based at least in part on the user interest record.
